(19) United States
(12) Patent Application Publication
(10) Pub. No.: US 2008/0121298 A1
(43) Pub. Date: May 29, 2008

(54) Shut-Off Device For A Pipe

(76) Inventor: Jan Norrman, Vaxholm (SE)

Correspondence Address: OSTROLENK FABER GERB & SOFFEN, 1180 AVENUE OF THE AMERICAS, NEW YORK, NY, 100368403, US

(21) Appl. No.: 11/720,407

(22) PCT Filed: Nov. 17, 2005
(86) PCT No.: PCT/SE2005/001731

§ 371 Date: May 29, 2007

(30) Foreign Application Priority Data
Nov. 30, 2004 (SE) 0402912-0

(51) Int. Cl. F16K 39/04

(52) U.S. Cl. 137/630.14

(57) ABSTRACT

Shut-off device for a pipe for a liquid, in particular pressurized crude oil, a pipe baffle, having an opening in the form of a valve seat for a valve flap placed upstream, being spring biased toward closed position, an appurtenant hydraulic cylinder being arranged to overcome the spring bias upon pressurizing in order to keep the flap in open position. An appurtenant hydraulic pipe extend along the liquid pipe and locally pressurizes the valve hydraulic cylinders, and a pump-out valve having a relatively small valve area through the stoppage has a throughput channel between the upstream and downstream side of the baffle, the pump-out valve being spring biased toward closed position and being kept open by a hydraulic cylinder, which is fed by the hydraulic pipe.

The invention relates to a shut-off device for a pipe of the kind that is seen in the preamble of claim 1.

The invention relates in particular to a shut-off device of the type the function of which is that, if the oil pipe is blasted, a valve device located upstream should automatically shut the oil pipe, in order to allow repairing of the pipe, after which arrangements should be made in order to facilitate restart of the transportation of liquid through the pipe after the repair.

For this sake, for the oil pipe, a shut-off device according to the appended independent claim 1 is provided. Embodiments are defined in the dependent claims.

Suitably, the oil pipe comprises a plurality of spaced-apart shut-off devices placed along the pipe, and the pipe may furthermore comprise devices that prevent a return flow from the part of the pipe located downstream to a point of rupture.

In the following, the invention will be described by way of examples, reference being made to the appended drawing.

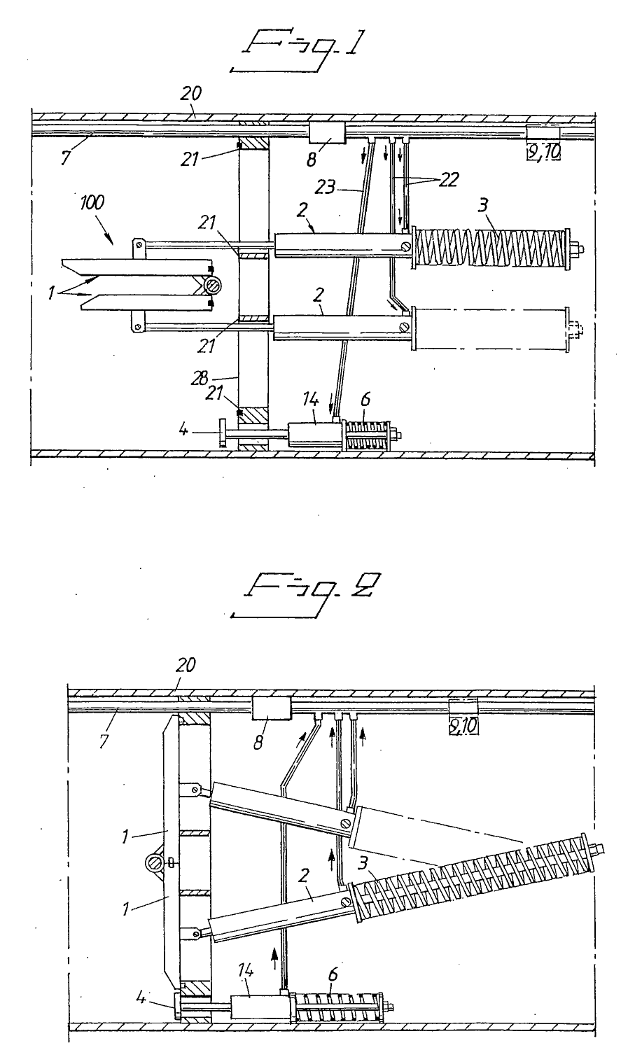

FIG. 1 schematically shows a device according to the invention, in open state.

FIG. 2 shows the device in closed state.

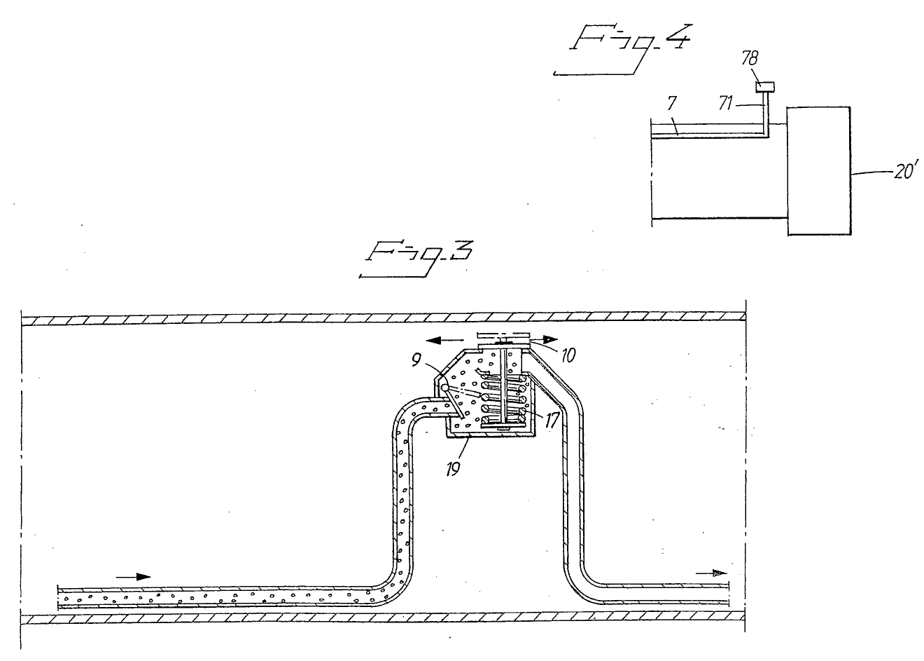

FIG. 3 schematically illustrates a non-return and air valve for a hydraulic pipe included in the device.

FIG. 4 schematically shows downstream the end of the oil pipe with the appurtenant hydraulic pipe.

FIG. 1 shows an oil pipe 20 having a baffle plate 28, which has a seat 21 and a turnably mounted valve flap 1, the mounting of which is situated at the diameter of the pipe 20. The flaps 1 seal against each other in the position they assume when they seal against a seat 21, which surrounds an appurtenant throughput channel through the baffle 28, so that also a central area of the baffle 28 can convey oil through in the open state of the valve device.

The valve flaps 1 are located on the upstream side and are biased toward closed state by a spring 3. A hydraulic cylinder 2 is pressure fed via a branch conduit 22 from a hydraulic pipe 7 and can, upon pressurizing, overcome the spring 3 in order to keep the flap 1 in open position. The two flaps 1 may have common mounting on the diameter of the pipe 20.

Through the baffle, also a pump-out valve channel of relatively small diameter extends. An appurtenant valve disc 4 is biased by a spring 6. A hydraulic cylinder counteracts the spring 6 upon pressurizing from the hydraulic pipe 7 via the feed line 23 in order to keep the valve 4 open when the hydraulic pipe has full pressure. If the pressure in the hydraulic pipe 7 disappears, the valve flaps 1 are closed and the valve 4 is closed. The hydraulic pipe 7 may contain a tube-rupture valve 8 downstream the baffle 28. A non-return and air valve 9, 10 are shown in FIG. 3. The hydraulic pipe 7 may be fed by oil. In FIG. 3, it can be seen that air bubbles in the oil of the hydraulic pipe can be separated by a ventilating/non-return valve 10, 9, so that gas-free oil leaves the device 9, 10.

By the fact that the valve 4 has a much smaller area than the valves 11, the valve 4 can be opened after a pipe blasting having been mended, as the pressure downstream the baffle 28 is substantially zero.

The possibly provided tube-rupture valve 8 guarantees that the hydraulic pipe 7 is not emptied upon a pipe blasting downstream the baffle 28. From FIG. 4, it can be understood that the hydraulic pipe 7 has an end section 71 in the down-stream end 20′ of the pipe 20. The end section 71 is provided with a discharge device 78 allowing to, from the end 20′ of the pipe, readily shut all shut-off devices along the pipe 20.

The function is that the hydraulic pressure in the pipe 7 disappears if the pipe 20 is blasted, upon which compression springs shut the valve flaps 1 and the pump-out valve 4. When the oil pipe and the hydraulic pipe are mended, the hydraulic system 7 is first restarted with elevated pressure, whereby the hydraulic pipes 7 are ventilated, possibly by the ventilating and non-return valves 9, 10 all the way up to the end station 20′. Simultaneously, the pump-out valve 4 is opened and crude oil is evacuated under remaining pressure. When the pressure has dropped sufficiently, the valve flaps 1 manage to be opened by the cylinders 2 thereof. Then the hydraulic pressure is lowered to normal level and the transportation of oil can be restarted. The oil pipe is provided with similar turnable valve flaps 1′, fixedly directed toward the other direction in order to freely prevent return flows of the crude oil in the opposite direction through the pipe 20. Said flaps (not shown) lack cylinders 2 and are self-closing and opening by the flow of oil.

Along an oil pipe, a plurality of shut-off devices may be provided at mutually chosen distances. Suitably, they are placed internally in the pipe 20 in order to be invisible from the outside and not be targets for a blasting. The placing entails an area reduction of the oil-transportation pipe. In order to retain high capacity, there are two solutions: either increasing the diameter of the entire pipe, but this is expensive. Alternatively, it is possible to increase the diameter of the pipe 20 at the shut-off device, but this has the drawback that a terrorist can see the position of the shut-off device. Then it is possible to increase the diameter of the pipe at each shut-off device.

Furthermore, it is possible to mount a number of false diameter increase portions (which do not contain any shut-off device) in order to make it difficult for a terrorist to choose correct place for a blasting.

1. Shut-off device for a pipe for a liquid, in particular pressurized crude oil, wherein by a shut-off unit comprising a pipe baffle having an opening in the form of a valve seat for a valve flap placed upstream, which is spring biased toward closed position, a hydraulic cylinder belonging to the flap being arranged to overcome the spring bias upon pressurizing in order to keep the flap in open position, a pump-out valve that has a small valve area in relation to the flap and has a throughput channel between the upstream and downstream side of the baffle, the pump-out valve being spring biased toward closed position and being kept open by a hydraulic cylinder, a hydraulic pipe, which extends along the pipe and is connected to a source of pressurized liquid, being connected to the hydraulic cylinder of the flap and the hydraulic cylinder of the pump-out valve.

2. Device according to claim 1, wherein a non-return and air valve is arranged in the hydraulic pipe downstream the pipe baffle.

3. Device according to claim 1, wherein the hydraulic pipe has a tube-rupture valve downstream the pipe baffle.

4. Device according to claim 1, wherein by a plurality of shut-off units spaced-apart along the pipe, each one of which has the hydraulic cylinders thereof connected to a nearby part of the hydraulic pipe.

5. Device according to claim 4, wherein the hydraulic pipe in the end part thereof located downstream has a discharge valve, which upon opening lowers the pressure of the hydraulic pipe and thereby allows the flap and the pump-out valve in the respective shut-off unit to be shut.

6. Device according to claim 5, wherein the discharge valve is a manually readjustable valve.

7. Device according to claim 5, wherein the valve has appurtenant remote-controlled driving members.

8. Device according to claim 1, wherein the valve flap to is turnably mounted between the shut position thereof and an open position, in which the area of extension of the flap is substantially parallel to the longitudinal direction of the pipe.

9. Device according to claim 8, wherein the valve seat of the pipe baffle has two appurtenant turnably mounted valve flaps, each one of which is spring biased toward a closed position and has an appurtenant hydraulic cylinder (2), which is arranged to, upon pressurizing from the hydraulic pipe, overcome the spring bias in order to keep the flap in open position and that the flaps 1, in closed position, are arranged to also seal against each other.

10. Device according to claim 2, wherein the hydraulic pipe has a tube-rupture valve downstream the pipe baffle.
